(19) United States
(12) Patent Application Publication
(10) Pub. No.: US 2012/0086385 A1
(43) Pub. Date: Apr. 12, 2012

(54) FUEL PROCESSOR/FUEL CELL SYSTEM FOR PROVIDING POWER TO REFRIGERATORS AT OUT-OF-GRID LOCATIONS, AND A METHOD OF USE THEREOF

(75) Inventors: Spyridon Masouras, Patras (GR); Maria Michalopoulou, Patras (GR); Nikolaos Triantafyllopoulos, Patras (GR); Nora Gourdoupi, Patras (GR); Thomas Halkides, Patras (GR); Andreas Stavrakas, Patras (GR)

(73) Assignees: Frigoglass S.A.I.C., Athens (GR); Advent Technologies, Athens (GR); HELBIO S.A. Hydrogen and Energy Production Systems, Rio (GR)

(21) Appl. No.: 13/268,372

(22) Filed: Oct. 7, 2011

(30) Foreign Application Priority Data
Oct. 7, 2010 (GR) 20100100581

(51) Int. Cl. H01M 8/06; H01M 10/44; H01M 8/24

(52) U.S. Cl. 320/101; 429/465; 429/423; 429/424; 429/425

(57) ABSTRACT

A power system is provided which includes hydrogen production via reformation of gaseous or liquid hydrocarbons and/or alcohol feedstocks, in combination with high temperature PEM fuel cells which function as a power source, particularly for beverage and/or water cooler appliances, refrigerators or freezers and methods of use thereof.

### CROSS-REFERENCE TO RELATED APPLICATIONS

This application claims priority to Greek Patent Application No. 20100100581, filed Oct. 7, 2010. The entire contents of the aforementioned patent application is incorporated herein by this reference.

### FIELD OF INVENTION

This invention is related to a power system comprising of hydrogen production via reformation of gaseous or liquid hydrocarbons and/or alcohol feedstocks and high temperature PEM fuel cells which function as a power source for beverage and/or water cooler appliances, refrigerators or freezers. The power system may or may not be interfaced with a battery.

### BACKGROUND INFORMATION

The use of hydrogen as an energy vector of the future has gained wide acceptance and is progressing along the road to implementation. Hydrogen has an extremely high energy density and can be produced from a wide range of sources (e.g. separation from water, biomass, or natural gas molecules, etc). Further, hydrogen is one of the most environment friendly energy production process due to the absence of any pollutant emissions. Hydrogen can be used in fuel cells to produce electricity or to co-generate heat and electricity, and is ideal for off-grid applications, including for example mobile applications such as vehicle propulsion or auxiliary systems and stationary combined heat and power (CHP) systems for domestic or commercial use.

A fuel cell is an electrochemical device that converts chemical energy directly into electrical energy and heat. One type of fuel cell is a proton exchange membrane fuel cell (PEMFC) which use a polymer electrolyte membrane that permits only protons to pass between the anode and the cathode. At the anode, hydrogen is reacted to produce protons that pass through the membrane. The electrons produced by this reaction travel through external circuit to form an electrical current. At the cathode, oxygen is reduced and reacts with the protons to form water.

The anodic and cathodic reactions are described by the following equations:

Anode: H₂→2H⁺+2e⁻ Oxidation

Cathode: ½O₂+2H⁺+2e⁻→H₂O Reduction

PEMFCs are divided in two subcategories according to their operating temperature.

Low temperature PEMFCs (LT PEMFCs) operate at temperatures below 100° C., while high temperature PEMFCs (HT PEMFCs) operate between 120-200° C. LT PEMFCs are very sensitive to carbon monoxide that may be present in the fuel feed, so they need hydrogen of high purity while at the same time the gases need to be humidified. Both of these requirements lead to an increase in complexity and operation cost of the system. Operation of the fuel cell at temperatures above 150° C. offers certain advantages which lead to compact and cost effective PEM fuel cells systems. However, materials with certain requirements need to be selected for the stack construction. Specifically, when operating at such temperatures, the bipolar plates, the membrane electrode assemblies, end plates, gaskets etc. all have to withstand the strong oxidative conditions and high operating temperature. Apart from the materials' selection, many other issues are involved in the engineering of a fuel cell stack in order to provide, for example, uniform distribution of reactants inside and to each separate cell, uniform temperature distribution in each cell, minimal resistive losses, no crossover, minimum pressure drop etc.

A fuel cell stack should be fed with hydrogen which can be produced through a fuel processor that converts a hydrocarbon (natural gas or liquefied petroleum gas “LPG”) into a fuel flow. The most commonly employed method involves hydrogen production by the reformation of hydrocarbon or oxygenate fuels. These include natural gas, propane, butane (LPG), methanol and ethanol as the representative of the biofuels. Natural gas is mostly methane, and can be reformed according to the reaction:

CH₄+H₂O→CO+3H₂ ΔH=49.3 kcal/mol

Propane, butane and ethanol can be reformed according to the reactions:

C₃H₈+3H₂O→3CO+7H₂ ΔH=119.0 kcal/mol

C₄H₁₀+4H₂O→4CO+9H₂ ΔH=155.3 kcal/mol

C₂H₅OH+H₂O→2CO+4H₂ ΔH=57.2 kcal/mol

As can be seen from the heats of reaction (ΔH), all of the reforming reactions are highly endothermic, requiring substantial amounts of heat input. A small fraction of that heat is supplied by the water-gas-shift reaction:

CO+H₂O→CO₂+H₂ ΔH=−9.8 kcal/mol

which occurs in the reforming reactor driving the concentrations of CO and CO₂ to thermodynamic equilibrium. Even so, there is a large deficit that must be covered by an external heat supply. This deficit becomes even larger since the reactions take place at temperatures in the range of 700-900° C. which means that the reactants must be heated-up to such temperatures. The required heat is typically supplied by placing the catalyst containing tubes of the reactor inside a fired furnace. This is a rather inefficient arrangement since there exist severe heat transfer limitations from the heat source to the reactor tubes and then to the catalyst particles where it is actually needed. Thus, traditional reactor configurations are very inefficient for distributed hydrogen generation, and new configurations must be developed to increase the efficiency and decrease the cost of such systems.

What is needed is an improved combination of the appropriate fuel processor with a high temperature PEM fuel cell stack which can lead to an independent, compact and lightweight power system ideal for off grid applications, that is further environmental friendly, silent, and able to operate with a variety of hydrocarbons or alcohol based fuels. Such a combination could beneficially function as a power source for beverage and/or water cooler appliances.

### SUMMARY OF THE INVENTION

The present invention provides a system and process for power production from gaseous or liquid hydrocarbons and alcohols. Such a system and process can beneficially be used to operate a beverage and/or water cooler system, refrigerator or freezer.

According to embodiments of the invention, power production is achieved via the reformation of fuel in the presence of steam to a hydrogen rich stream also known as reformate hydrogen. The conversion of the fuel to hydrogen takes place in a fuel processing system comprising several conversion reactors and heat exchangers. The effluent stream from the fuel processor is used as a feed to the anode inlet of a high temperature PEM fuel cell. The term “high temperature PEM fuel cell” as referred to herein refers to fuel cell that operates at temperatures higher than 120° C., and which is also equipped with polymer electrolyte membrane electrode assemblies. It is further noted that any number of fuel cells could be provided in the system such that, for example, a fuel cell stack comprising a plurality of fuel cells can be used to achieve the desired power production.

Inside the fuel cell, a part of the hydrogen is electrochemically oxidized to water. According to embodiments of the invention, the air required for the oxidation can be injected through the cathode inlet of the fuel cell. According to some embodiments of the invention, the high temperature PEM fuel cell operates at a temperature between about 120-200° C., and in some embodiments about 150-190° C. The system and fuel cell can be configured so as to provide a desired level of power production, preferably net powers of at least about 50 W, and reaching as high as about 5000 W depending on the desired application.

The fuel cell is integrated with a power conditioning subsystem. Such power conditioning subsystems primarily convert the low-voltage DC power generated by a fuel cell into high voltage power consistent with the system requirements, and can further improve power system performance. Typically, a first stage of the power conditioning subsystem regulates the fuel cell voltage to a desired voltage. Energy storage, such as batteries, can further be provided to assist in responding to rapid transients. The final stage of the power conditioning subsystem provides the regulated power, to a DC/DC converter or a DC/AC converter. The power conditioning subsystem of the invention may be configured generally in accordance with such conventional subsystems, and can include the various components typically used for suitable power conversion. For example, according to an embodiment of the present invention, the power conditioning subsystem includes a DC voltage stabilizer, DC/DC voltage converter and/or a DC/AC inverter, a battery charger, and a rechargeable battery. According to an exemplary embodiment of the present invention, the power conditioning subsystem is configured so as to provide the necessary power to a beverage and/or water cooling appliance, refrigerated display cabinet, refrigerator or freezer in order to sustain its operation.

### BRIEF DESCRIPTION OF THE DRAWINGS

For a fuller understanding of the nature and desired objects of the present invention, reference is made to the following detailed description taken in conjunction with the accompanying drawing figures wherein:

FIG. 1 shows a flow diagram of the integrated power production system with a refrigerator.

### DETAILED DESCRIPTION OF THE DRAWINGS

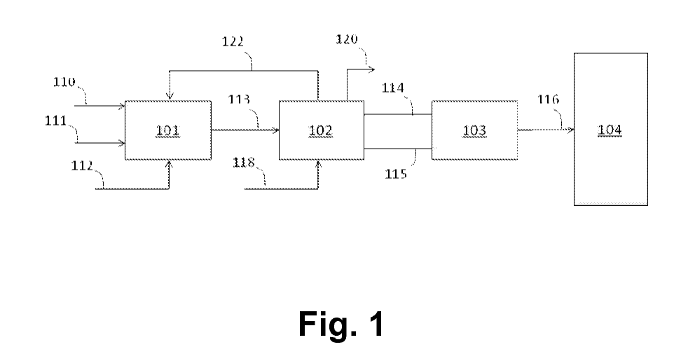

FIG. 1 illustrates a schematic of a process and system for power production in accordance with an embodiment of the invention. The process and system are particularly suitable for production of power for beverage and/or water coolers, refrigerated display cabinets, refrigerators, freezers and the like.

As shown in FIG. 1, the process includes the following steps: water (110), air (111) and fuel are first injected in the fuel processor (101). Within the fuel processor (101), the fuel is converted to a hydrogen rich stream employing a series of conversion reactors. The produced stream (113), which also known as reformate hydrogen, is fed to the fuel cell subsystem (102).

In the fuel cell subsystem (102), a part of the reformate hydrogen is electrochemically oxidized. In particular, as shown in FIG. 1, in order for the oxidation reaction of reformate hydrogen to take place, air (118) is introduced to the fuel cell subsystem (102). The un-reacted reformate hydrogen (122) is recycled to the fuel processor (101), while the exhausted air (120) is vented to the atmosphere. The electrochemical oxidation of the reformate hydrogen inside a fuel cell generates a DC tension between the negative (114) and positive (115) poles of the fuel cell.

As shown in FIG. 1, the negative (114) and positive (115) poles of the fuel cell are connected to a power conditioning subsystem (103). According to embodiments of the invention, this power conditioning subsystem (103) includes a DC voltage stabilizer, DC/DC voltage converter and/or a DC/AC inverter, a battery charger and a rechargeable battery. However, it should be understood that the power conditioning subsystem could also be provided with alternate arrangements of components in accordance with conventional subsystems which can be configured and arranged so as to provide power consistent with the system requirements. For example, in some embodiments, the power conditioning subsystem (103) may not be interfaced with a battery.

The power conditioning subsystem (103) is in connection with the object that is operated via the power production system. In an exemplary embodiment, the power conditioning subsystem (103) is configured so as to produce power suitable to power up a cooler (104) for beverages and/or water, refrigerated display cabinets, refrigerators or freezers. As such, the power conditioning subsystem (103) may suitably be in connection with the cooler (104), as shown in FIG. 1.

According to various embodiments of the invention, the system is configured such that the net power of the fuel cell stack is about 50-5000 W.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system comprising:
a fuel processor;
a high temperature PEM fuel cell stack operating at least at about 120° C., the high temperature PEM fuel cell stack being in connection with the fuel processor;
a power conditioning subsystem in connection with the high temperature PEM fuel cell stack; and
a beverage and/or water cooler, refrigerated display cabinet, refrigerator or freezer in connection with the power conditioning subsystem.

2. The system of claim 1 wherein the power conditioning includes a rechargeable battery, wherein power produced by the high temperature PEM fuel cell stack recharges the battery, and wherein the rechargeable battery provides power to the beverage and/or water cooler, refrigerated display cabinet, refrigerator or freezer.

3. The system of claim 1 wherein power produced by the high temperature PEM fuel cell stack provides power directly to the beverage and/or water cooler, refrigerated display cabinet, refrigerator or freezer

4. The system of claim 1 wherein the operating range of the high temperature PEM fuel cell stack is between about 120-200° C.

5. The system of claim 1 wherein the operating range of the high temperature PEM fuel cell stack is between about 150-190° C.

6. The system of claim 1 wherein the net power of the fuel cell stack is about 50-5000 W.

7. The system of claim 1 wherein the fuel processor includes an inlet into which a fuel selected from LPG, propane, methane, ethanol, methanol, gasoline, diesel, or kerosene is fed, and one or more conversion reactors and heat exchangers for converting the fuel to hydrogen.

8. The system of claim 1 wherein the fuel processor includes a water inlet for receiving tap water, internally recycled water, or distilled water.

9. The system of claim 1 wherein hydrogen produced in the fuel processor is fed to the a high temperature PEM fuel cell stack, and wherein the hydrogen output in the reformate stream ranges from about 25 vol % to 80 vol %

10. The system of claim 1 wherein the power conditioning subsystem comprises a DC voltage stabilizer, a DC/DC or a DC/AC inverter, and a DC battery charger.

11. The system of claim 10, wherein the power conditioning subsystem further comprises a rechargeable battery.

12. A method for providing power to a beverage and/or water cooler, refrigerated display cabinet, refrigerator or freezer comprising:
providing the system of claim 1;
injecting water, air and fuel into the fuel processor;
converting the fuel to reformate hydrogen in the fuel processor;
feeding the reformate hydrogen to the fuel cell subsystem and further feeding air to the fuel cell subsystem;
allowing oxidation of the reformate hydrogen in the fuel cell subsystem to thereby generate DC power;
converting the DC power from the fuel cell subsystem into high voltage power in the power conditioning subsystem; and
providing the converted power to the beverage and/or water cooler, refrigerated display cabinet, refrigerator or freezer.

13. The method of claim 12, wherein the power conditioning subsystem includes a rechargeable battery, wherein power produced by the high temperature PEM fuel cell stack is converted and provided to the rechargeable battery, and wherein the rechargeable battery provides power to the beverage and/or water cooler, refrigerated display cabinet, refrigerator or freezer.

14. The method of claim 12, wherein the fuel cell stack generates a net power of about 50-5000 W.
